(19) United States
(12) Patent Application Publication
(10) Pub. No.: US 2023/0234056 A1
(43) Pub. Date: Jul. 27, 2023

(54) MICROFLUIDIC SYSTEMS AND METHODS FOR SORTING PARTICLES

(71) Applicant: NanoCellect Biomedical, Inc., San Diego, CA (US)

(72) Inventors: Sung Hwan CHO, San Diego, CA (US); Ashley LO, San Diego, CA (US); Jason HANCOCK, San Diego, CA (US); Jose MORACHIS, San Diego, CA (US)

(21) Appl. No.: 18/002,019

(22) PCT Filed: Jun. 17, 2021
(86) PCT No.: PCT/US2021/037815

§ 371 Date: Dec. 15, 2022

Related U.S. Application Data
(60) Provisional application No. 63/166,694, filed on Mar. 26, 2021.
(60) Provisional application No. 63/041,067, filed on Jun. 18, 2020.

(51) Int. Cl. B01L 3/00; B32B 27/32; B32B 27/08; B32B 3/26; B32B 27/16; B32B 7/12; B32B 3/30

(52) U.S. Cl. CPC B01L 3/502761; B01L 3/502707; B32B 27/325; B32B 27/08; B32B 3/266; B32B 27/16; B32B 7/12; B32B 3/30; B01L 2200/12; B01L 2200/0652; B01L 2400/0439; B01L 2300/021; B01L 2200/027; B01L 2300/165; B01L 2300/168; B01L 2200/04; B32B 2307/412; B32B 2255/10; B32B 2457/08

(57) ABSTRACT

Provided herein are devices, systems, and methods for particle sorting, including cell sorting, using microfluidics cartridges and microchips and the manufacture of the microfluidics cartridges and microchips by high-throughput approaches. Such methods, devices, and systems can be used to identify, sort, and collect a subset of particles or a single particle from a sample. The capability to manufacture such microfluidic tools in high volume may lower production costs and allow for the microfluidic tools to be used as consumables.

### CROSS-REFERENCE TO RELATED APPLICATIONS

This application claims the benefit of U.S. Provisional Patent Application No. 63/041,067 filed on Jun. 18, 2020, and U.S. Provisional Patent Application No. 63/166,694 filed on Mar. 26, 2021. Priority is claimed pursuant to 35 U.S.C. § 119. The above noted patent applications are incorporated by reference as if set forth fully herein.

### BACKGROUND

The ability to identify, sort, and collect a single particle from a sample having a number of particles using microfluidics technology offers a powerful tool for research and for various applications in biology and medicine. Approaches that use disposable tools can reduce contamination risk and save time in instrument cleaning and preparation. The capability to manufacture such disposable tools in a high-throughput process may be valuable in commercially developing such devices, systems, and methods for particle sorting.

### SUMMARY

The devices, methods, and systems provided herein address a need for high-throughput and accurate manufacture of disposable microfluidics-based tools for particle sorting, analysis, and imaging.

Provided herein are microchips for sorting a plurality of particles in a sample comprising: a microfluidic chip substrate, the microfluidic chip substrate comprising a microchannel, at least two sorting channels, and an aperture that are configured to be in fluid communication with each other, wherein the microfluidic chip substrate comprises a cycloolefin polymer; a first cover layer, the first cover layer configured to cover the microfluidic chip substrate, wherein the first cover layer comprises a cycloolefin polymer; and a piezoelectric actuator, the piezoelectric actuator configured to cover the aperture on an opposite side of the microfluidic chip substrate from the first cover layer. In some embodiments, the cycloolefin polymer for the first cover layer is cyclic olefin copolymer (COC). In some embodiments, the first cover layer comprises a COC film. In some embodiments, the cycloolefin polymer for the first cover layer is cyclic olefin polymer (COP). In some embodiments, the microfluidic chip substrate is injection molded. In some embodiments, the cycloolefin polymer for the microfluidic chip substrate comprises COC. In some embodiments, the cycloolefin polymer for the microfluidic chip substrate comprises COP. In some embodiments, the cycloolefin polymer for the first cover layer or the microfluidic chip substrate has high optical transparency. In some embodiments, the cycloolefin polymer for the first cover layer or the microfluidic chip substrate has low autofluorescence. In some embodiments, the microchip further comprises a second cover layer, the second cover layer is configured to cover at least a portion of the first cover layer on an opposite side of the first cover layer from the microfluidic chip substrate. In some embodiments, the second cover layer is configured to cover entire area of the microfluidic chip substrate. In some embodiments, the second cover layer and the first cover layer are configured to cover the aperture of the microfluidic chip substrate. In some embodiments, the microfluidic chip substrate comprises an actuator reservoir in fluidic communication with a sorting junction, and a second reservoir in fluidic communication with the sorting junction, wherein the second reservoir is substantially opposite the actuator reservoir, and wherein the second cover layer has a cutout, the cutout configured to not cover at least a portion of the second reservoir. In some embodiments, the first cover layer and the second cover layer help maintain a pressure in the aperture, the pressure lower than a pressure required for delaminating the first cover layer or the piezoelectric actuator from the microfluidic chip substrate. In some embodiments, the first cover layer and the second cover layer cover the microfluidic chip substrate to allow or do not restrict a fluid flow in the microchannel and the at least two sorting channels of the microfluidic chip substrate.

Provided herein are microchips for sorting a plurality of particles in a sample comprising: a microfluidic chip substrate, the microfluidic chip substrate comprising a microchannel, at least two sorting channels, and an aperture that are configured to be in fluid communication with each other, wherein the microfluidic chip substrate comprises a cycloolefin polymer; a first cover layer, the first cover layer configured to cover the microfluidic chip substrate, wherein the first cover layer comprises a cycloolefin polymer; and a piezoelectric actuator, the piezoelectric actuator configured to cover the aperture on an opposite side of the microfluidic chip substrate from the first cover layer, and wherein the piezoelectric actuator comprises lead zirconate titanate (PZT). In some embodiments, an adhesive is used to cover the aperture of the microfluidic chip substrate with the piezoelectric actuator, wherein the adhesive is a pressure sensitive adhesive (PSA). In some embodiments, the microchip is surface treated to change hydrophilicities of the microchannel, the at least two sorting channels, and the aperture of the microfluidic chip substrate. In some embodiments, the surface treatment is at least one of surface coating, attachment of active groups, plasma oxidation, thermal aging, and chemical coating. In some embodiments, the microchip is configured to connect to a macro cartridge, the macro cartridge comprising a cycloolefin polymer and having a cutout configured to hold the microchip. In some embodiments, the macro cartridge comprises cycloolefin polymer. In some embodiments, the macro cartridge is configured to attach to a film backing on an opposite side of the macro cartridge from the microchip. In some embodiments, the film backing comprises cycloolefin polymer. In some embodiments, an adhesive is used to attach the microchip to the macro cartridge, wherein the adhesive is a pressure sensitive adhesive (PSA). In some embodiments, the microchip further comprises a piezoelectric actuator neck, a sample inlet, a sheath inlet, a purge hole, a purge neck, an outlet connected to each of the sorting channels, a triangular channel opposite the actuator neck, and at least two sets of alignment markers. In some embodiments, the macro cartridge further comprises an identification tag.

Provided herein are microfluidic cartridges for sorting a plurality of particles in a sample comprising: a microchip, the microchip comprising a microfluidic chip substrate, the microfluidic chip substrate comprising a microchannel, at least two sorting channels, and an aperture that are configured to be in fluid communication with each other, wherein the microfluidic chip substrate comprises a cycloolefin polymer; a first cover layer, the first cover layer configured to cover the microfluidic chip substrate, wherein the first cover layer comprises a cycloolefin polymer; and a piezoelectric actuator, the piezoelectric actuator configured to cover the aperture on an opposite side of the microfluidic chip substrate from the first cover layer; and a macro cartridge comprising a cycloolefin polymer and having a cutout configured to hold the microchip.

Provided herein are methods of preparing a microchip for sorting a plurality of particles in a sample comprising: (a) fabricating a microfluidic chip substrate, the microfluidic chip substrate comprising a microchannel, at least two sorting channels, and an aperture that are configured to be in fluid communication with each other, wherein the microfluidic chip substrate comprises a cycloolefin polymer; (b) aligning a first cover layer comprising a cycloolefin polymer on one side of the microfluidic chip substrate and a piezoelectric actuator on the other side of the microfluidic chip substrate, wherein the piezoelectric actuator covers the aperture of the microfluidic chip substrate; and (c) attaching the first cover layer and the piezoelectric actuator to the microfluidic chip substrate. In some embodiments, the fabrication in step (a) is by injection molding. In some embodiment, the method further comprises aligning and attaching a second cover layer to cover at least a portion of the first cover layer on an opposite side of the first cover layer from the microfluidic chip substrate. In some embodiments, the method further comprises treating surfaces of the microchip by at least one of surface coating, attachment of active groups, plasma oxidation, thermal aging, and chemical coating.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 shows an example of the microfluidic cartridge having a microchip and a macro cartridge assembly.

FIG. 2 shows an example of the microfluidic cartridge having a microchip having a second cover layer and a macro cartridge assembly.

FIG. 3A shows an example of the microfluidic cartridge comprising a macro cartridge and a microchip.

FIG. 3B shows an example of the microfluidic cartridge inserted into the system for particle sorting.

FIG. 4 shows an example of a microfluidic chip substrate of a microchip having a circular aperture for actuator, an actuator neck region connecting the aperture to the microchannel, three sorting channels, and a second reservoir or channel. Each sorting channel usually is connected an outlet.

FIG. 5 shows an example of a microfluidic chip substrate of a microchip having a sample inlet hole where a sample having a plurality of particles can enter and a sheath fluid inlet hole where the sheath fluid can enter the microfluidic chip substrate.

FIG. 6 shows an example of a zoomed-in view of a microfluidic chip substrate near the sorting junction with two sets of alignment markers.

### DETAILED DESCRIPTION

Provided herein are devices, systems, and methods for particle sorting, including cell sorting, using microfluidics tools and the manufacture of the microfluidic tools by high-throughput approaches. Such methods, devices, and systems can be used to identify, sort, and collect a subset of particles or a single particle from a sample. Using microfluidics tools for particle sorting allows for miniaturization of the process as compared to traditional flow cytometry systems.

Disclosed herein are methods, devices, and systems comprising microfluidics tools, including but not limited to microfluidic cartridges and microchips, for particle sorting produced by large scale manufacturing process. The capability to manufacture such microfluidic tools in high volume may lower production costs and allow for the microfluidic tools to be used as consumables. By using a new disposable microfluidics tool for a new sample, the use of disposable microfluidics tools may reduce contamination risk and save time in instrument cleaning and preparation. The use of disposable microfluidics tools may also provide ability to sort the particles in an aseptic environment, which can be beneficial for downstream analysis. Sorting under aseptic conditions may allow for aseptic culturing of the sorted particles, such as hybridomas, and improve the results of other downstream analysis, such as gene or genome sequencing. Sorting under aseptic conditions may allow for the sorting of samples for use in therapies, including adoptive cell therapies. A high-throughput manufacturing process can reduce the time and cost of production, be automated, reduce the number of steps in manufacturing, and improve the precision in manufacturing process and the precision in the microfluidics tools. The improvement in the precision of the microfluidic tools may improve the particle sorting results. A fabrication process and choice of materials conducive for a high-volume production may facilitate the commercial development of the microfluidic devices and systems. As such, the devices, systems, and methods described herein may provide a cost effective, accurate, compact approach for particle sorting.

Disclosed herein are methods, devices, and systems comprising microfluidics tools for particle sorting by using materials conducive for high-throughput manufacturing process, including but not limited to thermoplastics. The material for any portion of the microfluidic tool may be chosen to have high optical transparency, low autofluorescence, a target range of mechanical properties, and compatibility for mass manufacturing. Usually, the material is compatible with injection molding or other large-scale production methods.

Provided herein are methods, devices, and systems comprising a microchip for sorting a plurality of particles in a sample comprising a microfluidic chip substrate, a first cover layer, and a piezoelectric actuator. The microfluidic chip substrate may be made of or include a component made of a cycloolefin polymer, including but not limited to cyclic olefin copolymer (COC) and cyclic olefin polymer (COP). Alternatively or in combination, the microfluidic chip substrate may be made of a thermoplastic. The microfluidic chip substrate comprises a microchannel, at least two sorting channels, and an aperture that are configured to be in fluid communication with each other. The first cover layer may be made of a cycloolefin polymer and configured to cover one side of the microfluidic chip substrate. The piezoelectric actuator may be configured to cover the aperture on an opposite side of the microfluidic chip substrate from the first cover layer. In some cases, the aperture forms a void or reservoir between the first cover layer and the piezoelectric actuator.

Sometimes, the microchip further comprises additional components to secure the components and improve its particle sorting capability. The microchip may have a second cover layer that can help to secure the first cover layer to the microfluidic chip substrate. The second cover layer covers at least a portion of the first cover layer and may cover the entire microfluidic chip substrate or a portion of the microfluidic chip substrate. In some cases, the second cover layer may cover an aperture of the microfluidic chip substrate covered by the piezoelectric actuator on the other side of the microfluidic chip substrate and leave a microchannel and at least two sorting channels of the microfluidic chip substrate uncovered. Usually, the first and second cover layers help to control and maintain a pressure in the aperture of the microfluidic chip substrate covered by the actuator. The pressure is typically at a level lower than that required for delaminating the first cover layer or the piezoelectric actuator from the microfluidic chip substrate. The first and second cover layers may cover the microfluidic chip substrate in a way to help a fluid flow and maintain the fluid flow in a microchannel and sorting channels in the microfluidic chip substrate. In some cases, the microchip may have an adhesive layer, including but not limited to pressure sensitive adhesive (PSA), to help secure two components together. Usually, the microchip further comprises at least one of a piezoelectric actuator neck, a sample inlet, a sheath inlet, a purge hole, a purge neck, an outlet connected to each of the sorting channels, a second reservoir or channel, and sets of alignment markers. The second reservoir or channel can be shaped as a triangle, which can assist with purging gas from the microchip when filling the microchip with liquid. The second reservoir or channel can be placed on the sorting junction opposite or substantially opposite from the actuator chamber.

The microchip can be configured to connect to a macro cartridge for particle sorting to form a microfluidic cartridge. The microfluidic cartridge having the microchip can be connected to a particle sorting device or system to process the particles in a sample. Often, the microfluidic cartridge is disposable after one use for particle sorting in the methods, devices, and systems described herein. The macro cartridge may be made of cycloolefin polymer, including but not limited to COC and COP, and may comprise a cutout configured to hold the microchip. Sometimes, the macro cartridge is configured to attach to a film backing on an opposite side of the cartridge from the microchip. The film backing may be made of cycloolefin polymer.

The use of cycloolefin polymer, such as cyclic olefin copolymer (COC) and cyclic olefin polymer (COP), in the microchip components and microfluidic cartridge provides various advantages. While polydimethylsiloxane (PDMS) is commonly used in microfluidic devices due to its high optical transmittivity and high gas permittivity, PDMS can suffer from solvent swelling, channel deformation, and devices using PDMS can be more difficult to manufacture, especially in large quantities. The use of cycloolefin polymer allows the microchip or microfluidic cartridge components, such as the microfluidic chip substrate and the first cover layer, to be prepared by injection molding or other processing technique compatible with large scale manufacturing, including but not limited to injection molding, laser etching, 3D printing, hot embossing, and roller embossing. The use of cycloolefin polymer allows for high-throughput fabrication provides a fast, low-cost, and accurate approach to scale up the fabrication of the microchips or the microfluidic cartridges, having a high accuracy and high consistency across different batches of the microchip or the microfluidic cartridges. The cycloolefin polymer provides a material having a high optical transparency and low autofluorescence. These features are beneficial for particle sorting methods, devices, and systems as they may allow for imaging or detecting the particles in a sample with low interference from the material itself, especially if the detection is by fluorescence. Often, the material is compatible with surface treatments, including but not limited to surface coating, attachment of active groups, plasma oxidation, thermal aging, and chemical coating, to change its hydrophilicity or hydrophobicity. As such, the microchip or the microfluidic cartridge can be treated in whole or in part to tune its hydrophilicity or hydrophobicity to have a desired physical property.

The methods, devices, and systems disclosed herein may be used to sort a number of different types of particles from a sample. For example, the methods, devices, and systems provided herein may be used to sort different types of cells in a biological sample. Sometimes, the particles that are sorted may be a bacterium, a virus, a micelle, a vesicle, a droplet, or any discrete object that can be distinguished from its surrounding medium. A sample usually comprises a plurality of these particles and can be processed to sort a single particle individually or a grouping of particles using the devices, systems, and methods described herein.

### I. Microfluidic Cartridge

The methods, devices, and systems provided herein comprise microfluidic cartridges having a microchip for sorting of particles in a sample. Usually, the microfluidic cartridge having a microchip is placed into a device and a system for particle sorting before the sample is introduced and sorting begins. Often, the microfluidic cartridge is disposable, and a new microfluidic cartridge is used for an individual sample. The microfluidic cartridge comprises various components that receive the particles in the sample in a fluid flow in a microchannel and sort the particles by one or more characteristics by the action of an actuator into one or more sorting channels.

Often, a microfluidic cartridge for sorting a plurality of particles in a sample comprises a macro cartridge and a microchip having a microfluidic chip substrate, a first cover layer, and an actuator. The microfluidic chip substrate usually comprises a microchannel, at least two sorting channels, and an aperture that are configured to be in fluid communication with each other, wherein the microfluidic chip comprises a cycloolefin polymer. The first cover layer may be configured to cover the microfluidic chip substrate, where the first cover layer comprises a cycloolefin polymer. The piezoelectric actuator may be configured to cover the aperture on an opposite side of the microfluidic chip substrate from the first cover layer. Usually, the macro cartridge comprises a cutout configured to hold the microchip.

In some embodiments, a microchip may be configured to connect to a macro cartridge to form a microfluidic cartridge for particle sorting. The macro cartridge can include a plurality of ports or valves that can be fluidically connected to an operating machine, including containers for samples and sheath fluid, using tubing or pipes. In some embodiments, the macro cartridge is made of a cycloolefin polymer. In some embodiments, the macro cartridge is made of at least one of COC, COP, or CBC. In some embodiments, the cycloolefin polymer for the macro cartridge has is optically transparent, which includes cartridges with high optical transparency, also referred herein as optical transmittivity. In some embodiments, the cycloolefin polymer for the macro cartridge does not autofluoresce or has low autofluorescence. In some embodiments, the cycloolefin polymer for the macro cartridge has low bifringence.

Sometimes the macro cartridge is configured to attach to a film backing on an opposite side of the macro cartridge from the microchip. In some cases, the film backing comprises cycloolefin polymer. In some cases, an adhesive is used to attach the microchip to the macro cartridge. In some cases, a PSA is used to attach the microchip to the macro cartridge.

Often, the macro cartridge comprises an identification tag. In some embodiments, the cartridge identification tag is a RFID tag. In some embodiments, the cartridge identification tag comprises a QR code, a barcode, or a serial number. In some embodiments, the cartridge identification tag can be scanned by an optical imaging or detection module of the particle sorting device or system.

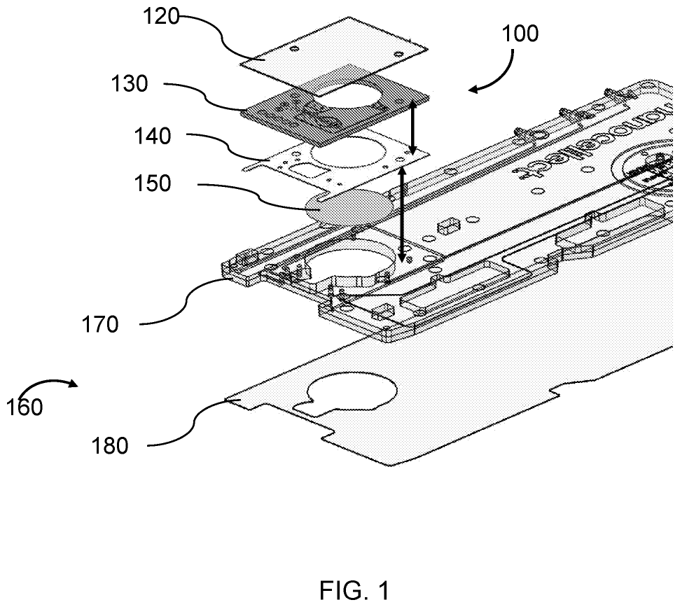

FIG. 1 shows an example of the microfluidic cartridge having a microchip 100 and a macro cartridge assembly 160. In some cases, the microchip 100 comprises a first cover layer 120, a microfluidic chip substrate 130, an adhesive layer 140, and an actuator 150. The macro cartridge assembly 160 comprises a macro cartridge 170 and a backing 180.

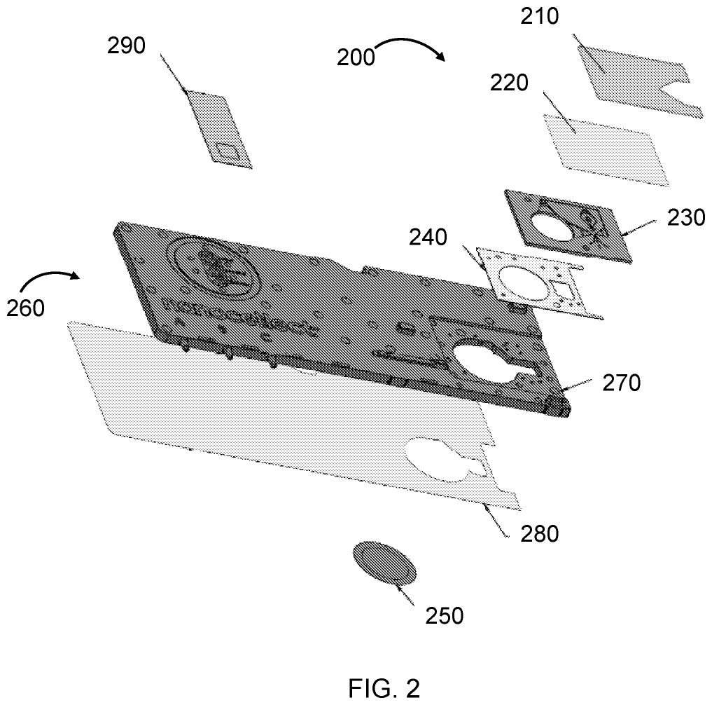

Sometimes, the microfluidic cartridge comprises a second cover layer that is configured to cover at least a portion of the first cover layer. FIG. 2 shows an example of the microfluidic cartridge having a microchip 200 having a second cover layer 210 and a macro cartridge assembly 260. In some cases, the microchip 200 comprises a second cover layer 210, a first cover layer 220, a microfluidic chip substrate 230, and an adhesive layer 240. The macro cartridge assembly 260 comprises a macro cartridge 270 and a backing 280. In some cases, the actuator 250 may be on an opposite side of the macro cartridge 270 from the microfluidic chip substrate 230. In some cases, the microfluidic cartridge comprises an identification tag 290 on the macro cartridge 270.

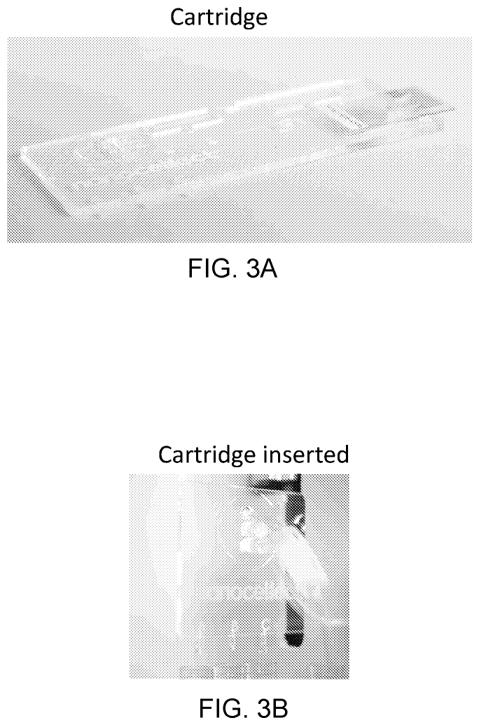

FIG. 3A shows an example of the microfluidic cartridge comprising a macro cartridge and a microchip. FIG. 3B shows an example of the microfluidic cartridge inserted into the system for particle sorting.

### II. Microchip

Described herein are methods, devices, and systems comprising a microfluidics cartridge having a microchip for particle sorting. Often, the microchip is configured to provide a concentrated area for the mechanism for particle sorting on the microfluidic cartridge. Sometimes, this concentrated area allows for focusing the visualization and identification module to a small area of the microfluidic chip substrate. The microchip may comprise a first cover layer, a microfluidic chip substrate, and an actuator and is in fluid connection to a macro cartridge to form a microfluidic cartridge.

The microfluidic chip substrate may comprise a microchannel, at least two sorting channels, and an aperture for an actuator that are connected and configured to be in fluid communication with each other under liquid flow. The main microchannel may terminate at the sorting junction. The sorting junction may be connected and in fluid communication with plurality of sorting channels, which may also be called output channels. In some embodiments, the microfluidic chip substrate comprises at least 2, 3, 4, 5, 6, 7, 8, 9, or 10 sorting channels. In some embodiments, the microfluidic chip substrate has three sorting channels. At the sorting junction, the aperture for the actuator, also referred to as an actuator chamber, a PZT chamber, a PZT reservoir or a PZT hole, comprises an actuator chamber neck. The actuator chamber neck narrows and focus flow of the liquid in the actuator chamber as it flows out of the actuator reservoir and into the sorting junction. The actuator chamber neck can cut across the sorting junction or the path of liquid flowing out of the main microchannel at an angle. Sometimes, the angle from the centerline of the actuator chamber neck to the sorting junction is about 45, 60, 75, or 90 degrees. On the other side of the microchannel-sorting channel path from the actuator chamber neck is a second reservoir or channel.

In some embodiments, the microfluidic chip substrate is made of a cycloolefin polymer. In some embodiments, the microfluidic chip substrate is made of at least one of COC, COP, or CBC. In some embodiments, the microfluidic chip substrate is made of COC. In some embodiments, the microfluidic chip substrate is prepared by at least one of injection molding, extrusion, film extrusion, injection blow molding, extrusion blowing, hot embossing, roller embossing, computer numerical controlled (CNC) milling, laser ablation, digital craft cutting, and 3D printing. In some embodiments, the microfluidic chip substrate is injection molded. Often, the microchip comprises at least one of a piezoelectric actuator neck, a sample inlet, a sheath inlet, a purge hole, a purge neck, an outlet connected to each of the sorting channels, a second reservoir or channel, or at least two sets of alignment markers.

The first cover layer can be configured to cover the microfluidic chip substrate, in whole or in part, in order to keep the microchannel, the sorting channels, and the PZT reservoir or aperture of the microfluidic chip substrate covered. In some embodiments, the first cover layer is made of a cycloolefin polymer. In some embodiments, the first cover layer is made of at least one of COC, COP, or CBC. In some embodiments, the first cover layer is made of a COC film. In some embodiments, the COC film is film extruded. In some embodiments, the cycloolefin polymer for the first cover layer has high optical transparency, also referred herein as optical transmittivity. In some embodiments, the cycloolefin polymer for the first cover layer has low autofluorescence. In some embodiments, the cycloolefin polymer for the first cover layer has low bifringence. In some embodiments, the first cover layer is directly bonded to the microfluidic chip substrate. In some embodiments, the direct bonding between the first cover layer and the microfluidic chip substrate is at least one of thermal fusion bonding, welding, surface modification by UV and/or ozone, or solvent bonding.

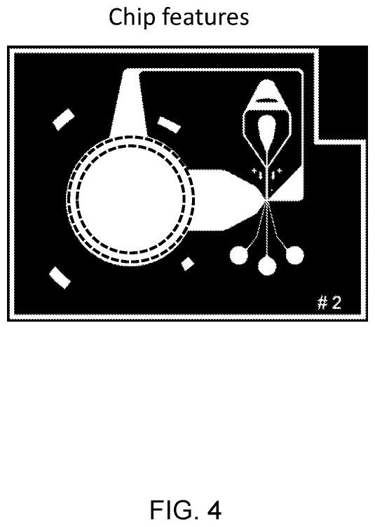

FIG. 4 shows an example of a microfluidic chip substrate of a microchip having a circular aperture for actuator, an actuator neck region connecting the aperture to the main microchannel, three sorting channels, and a second reservoir that are connected to each other. Each sorting channel usually is connected an outlet.

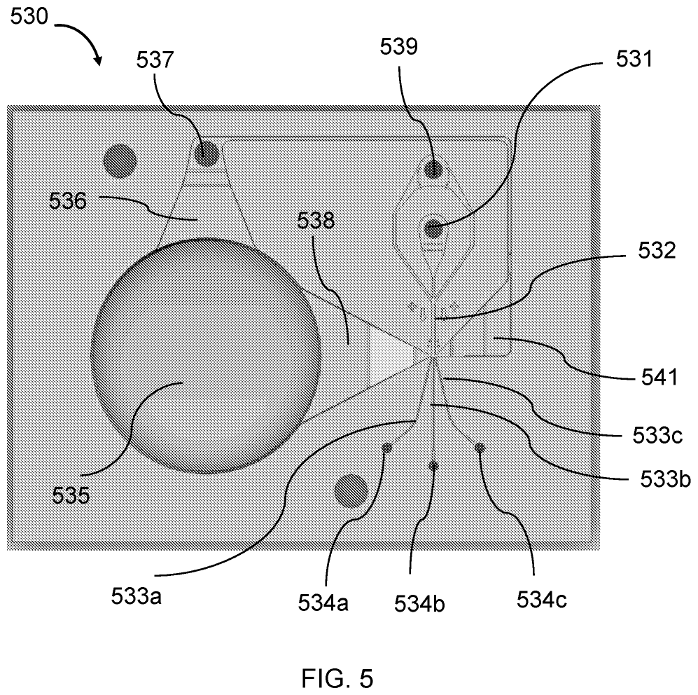

FIG. 5 shows an example of a microfluidic chip substrate 530 of a microchip having a sample inlet hole 531 where a sample having a plurality of particles suspended in a liquid can enter the microchannel and a sheath fluid inlet hole 539 where the sheath fluid can enter the microfluidic chip substrate. In some embodiments, the sample inlet hole 531 is fluidly connected to the microchannel 532 and the sorting junction, which splits into sorting channels 533a, 533b, 533c that are connected to outlets 534a, 534b, 534c. In some embodiments, the microfluidic chip substrate 530 has an aperture 535 for actuator, also referred to as a PZT hole, that forms an actuator chamber together with the actuator and the first cover layer. The aperture may be connected to a PZT neck 538 which is connected to the sorting junction on one side and to a purge neck 536 and a purge hole 537 on another side. The purge hole 537, also referred to as a purge port, allows for venting of gas from the fluid in the microfluidic chip substrate to ensure that the actuator chamber and triangular channel chamber are filled completely with liquid. In some embodiments, the microfluidic chip substrate 530 has a second reservoir or channel 541 that is connected to the purge neck 536 and the sorting junction across from the PZT neck 538. In some embodiments, the sheath fluid and the sample fluid are transmitted to the sorting junction, where different particles in the sample are directed into one of the sorting channels 533a, 533b, 533c. The sorting is carried out by an actuator covering the aperture of the microfluidic chip substrate that can deflect the sample fluid into one of the sorting channels 533a, 533b, 533c.

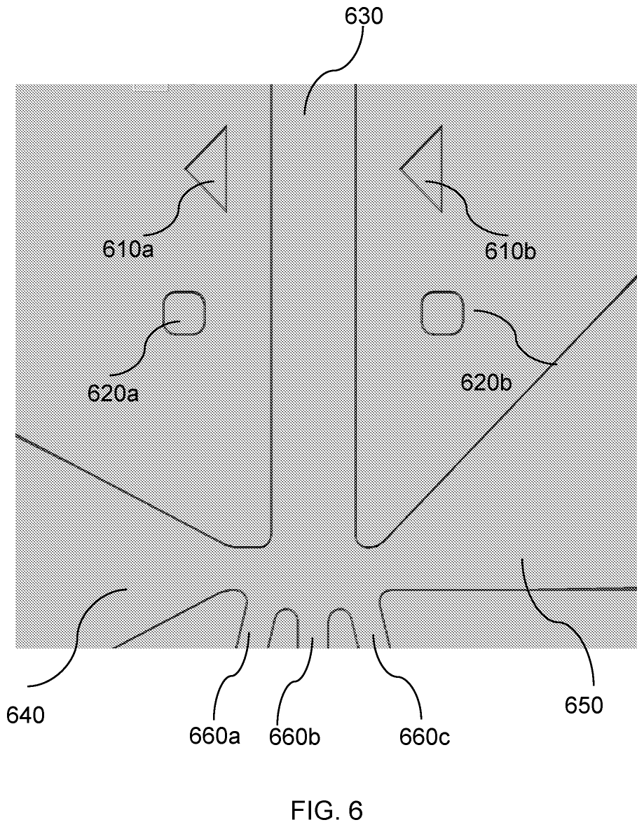

Sometimes alignment markers on the microfluidic chip substrate of the microchip are used to calibrate and adjust the optical imaging system for the particle sorting devices and systems. In some embodiments, one set of alignment markers are distinguished from another set of alignment markers by their shape, dimension, opacity, or another feature. In some embodiments, the microfluidic chip substrate near the sorting junction has at least 1, 2, 3, 4, or 5 sets of alignment markers. In some embodiments, one set of alignment markers are used to align the microchip and the cartridge in one direction. In some embodiments, one set of alignment markers are used to align the microchip and the cartridge in two directions. In some embodiments, one set of alignment markers are used to align the microchip and the cartridge in X-Y directions. In some embodiments, one set of alignment markers are used to align the microchip and the cartridge in three directions (e.g. XYZ directions). FIG. 6 shows an example of a zoomed-in view of a microfluidic chip substrate near the sorting junction with two sets of alignment markers 610a, 610b, 620a, 620b. The microfluidic chip substrate in FIG. 6 shows a set of triangle alignment makers 610a, 610b and a set of square alignment markers 620a, 620b along the either side of the main microchannel 630. In some embodiments, the sorting junction is connected to the main microchannel 630, three sorting channels 660a, 660b, 660c, a PZT neck 640, and a second reservoir or channel 650. In some embodiments, the set of triangle alignment makers 610a, 610b is used for Z-direction alignment and the set of square alignment markers 620a, 620b are used for XY-direction alignment.

Sometimes a second cover layer may cover the first cover layer on the opposite side of the first cover layer from the microfluidic chip substrate. In some cases, the second cover layer and the first cover layer are configured to cover the entire area of the microfluidic chip substrate. Alternatively, the second cover layer and the first cover layer may be configured to cover the aperture of the microfluidic chip substrate. In some cases, the second cover layer has a cutout, the cutout configured to not cover the microchannel and the at least two sorting channels of the microfluidic chip substrate. The first cover layer and the second cover layer help maintain a pressure in the aperture, the pressure lower than a pressure required for delaminating the first cover layer or the piezoelectric actuator from the microfluidic chip substrate. Usually, the first cover layer and the second cover layer cover the microfluidic chip substrate to allow or do not restrict a fluid flow in the microchannel and the at least two sorting channels of the microfluidic chip substrate.

In some cases, the first cover layer and the second cover layer are made of materials having the same material properties. In some cases, the first cover layer and the second cover layer are made of materials having different material properties. In some cases, the first cover layer has a higher elastic modulus than the second cover layer. In some cases, the first cover layer has a lower elastic modulus than the second cover layer. In some cases, the first cover layer has the same elastic modulus than the second cover layer. In some cases, the first cover layer has a higher tensile modulus than the second cover layer. In some cases, the first cover layer has a lower tensile modulus than the second cover layer. In some cases, the first cover layer has the same tensile modulus than the second cover layer. In some cases, the first cover layer has a higher tensile strength than the second cover layer. In some cases, the first cover layer has a lower tensile strength than the second cover layer. In some cases, the first cover layer has the same tensile strength than the second cover layer. In some cases, the first cover layer has a higher ultimate tensile strength than the second cover layer. In some cases, the first cover layer has a lower ultimate tensile strength than the second cover layer. In some cases, the first cover layer has the same ultimate tensile strength than the second cover layer. In some cases, the first cover layer has a higher hardness than the second cover layer. In some cases, the first cover layer has a lower hardness than the second cover layer. In some cases, the first cover layer has the same hardness than the second cover layer. In some cases, the first cover layer has a higher compressive modulus than the second cover layer. In some cases, the first cover layer has a lower compressive modulus than the second cover layer. In some cases, the first cover layer has the same compressive modulus than the second cover layer. In some cases, the first cover layer has a higher flexibility than the second cover layer. In some cases, the first cover layer has a lower flexibility than the second cover layer. In some cases, the first cover layer has the same flexibility than the second cover layer.

In some cases, the tensile modulus of the first cover layer is at least 10 MPa, 20 MPa, 30 MPa, 40 MPa, 50 MPa, 60 MPa, 70 MPa, 80 MPa, 90 MPa, or 100 MPa. In some cases, the tensile modulus of the first cover layer is no more than 10 MPa, 20 MPa, 30 MPa, 40 MPa, 50 MPa, 60 MPa, 70 MPa, 80 MPa, 90 MPa, or 100 MPa. In some cases, the tensile modulus of the first cover layer is measured by ISO 527-2/1A test standard. In some cases, the tensile strain at failure of the first cover layer is at least 100%, 200%, 300%, 400%, 500%, 600%, 700%, 800%, 900%, or 1000%. In some cases, the tensile strain at failure of the first cover layer is no more than 100%, 200%, 300%, 400%, 500%, 600%, 700%, 800%, 900%, or 1000%. In some cases, the tear strength of the first cover layer is at least 10 kN/m, 20 kN/m, 30 kN/m, 40 kN/m, 50 kN/m, 60 kN/m, 70 kN/m, 80 kN/m, 90 kN/m, or 100 kN/m. In some cases, the tear strength of the first cover layer no more than 10 kN/m, 20 kN/m, 30 kN/m, 40 kN/m, 50 kN/m, 60 kN/m, 70 kN/m, 80 kN/m, 90 kN/m, or 100 kN/m. In some cases, the tensile strain at failure of the first cover layer is measured by ISO 527-2/1A test standard. In some cases, the tear strength of the first cover layer is measured by ISO 34-1 test standard.

In some cases, the tensile modulus of the second cover layer is at least 10 MPa, 20 MPa, 30 MPa, 40 MPa, 50 MPa, 60 MPa, 70 MPa, 80 MPa, 90 MPa, or 100 MPa. In some cases, the tensile modulus of the second cover layer is no more than 10 MPa, 20 MPa, 30 MPa, 40 MPa, 50 MPa, 60 MPa, 70 MPa, 80 MPa, 90 MPa, or 100 MPa. In some cases, the tensile modulus of the second cover layer is measured by ISO 527-2/1A test standard. In some cases, the tensile strain at failure of the second cover layer is at least 100%, 200%, 300%, 400%, 500%, 600%, 700%, 800%, 900%, or 1000%. In some cases, the tensile strain at failure of the second cover layer is no more than 100%, 200%, 300%, 400%, 500%, 600%, 700%, 800%, 900%, or 1000%. In some cases, the tear strength of the second cover layer is at least 10 kN/m, 20 kN/m, 30 kN/m, 40 kN/m, 50 kN/m, 60 kN/m, 70 kN/m, 80 kN/m, 90 kN/m, or 100 kN/m. In some cases, the tear strength of the second cover layer no more than 10 kN/m, 20 kN/m, 30 kN/m, 40 kN/m, 50 kN/m, 60 kN/m, 70 kN/m, 80 kN/m, 90 kN/m, or 100 kN/m. In some cases, the tensile strain at failure of the second cover layer is measured by ISO 527-2/1A test standard. In some cases, the tear strength of the second cover layer is measured by ISO 34-1 test standard.

Often, the second cover layer and the first cover layer are sized and placed to cover the aperture and the PZT neck of the microfluidic chip substrate. In some cases, the aperture and the PZT neck are as illustrated by 535 and 538 in FIG. 5. In some cases, the second cover layer sized and placed to cover the aperture and the purge hole. An example of the purge hole of the microfluidic chip substrate is illustrated by 537 in FIG. 5 In some cases, the second cover layer is sized and placed to cover the aperture, the purge hole, the sheath fluid inlet hole, and the sample inlet hole of the microfluidic chip substrate. An example of the sheath fluid inlet hole and sample inlet hole of the microfluidic chip substrate are illustrated by 539 and 531 in FIG. 5. In some cases, the second cover layer is sized and placed to cover the aperture, the purge hole, the sheath fluid inlet hole, the sample inlet hole, the microchannel, the sorting junction, and the sorting channels of the microfluidic chip substrate. An example of the microchannel is illustrated by 532 of FIG. 5. An example of the sorting channels of the microfluidic chip substrate are illustrated by 533a, 533b, and 533c in FIG. 5. In some cases, the second cover layer is sized and placed to cover the aperture, the purge hole, the sheath fluid inlet hole, the sample inlet hole, the sorting junction, the sorting channels, the second reservoir or channel chamber of the microfluidic chip substrate. An example of the second reservoir or channel of the microfluidic chip substrate is illustrated by 541 in FIG. 5. In some cases, the first cover layer and the second cover layer are each sized and placed to cover the entire microfluidic chip substrate.

The aperture of the microfluidic chip substrate in the microchip may be covered by an actuator to form an actuator chamber, together with the first cover layer on the other side of the aperture. Often, the actuator of the microchip is a piezoelectric actuator. Sometimes, the actuator comprises lead zirconate titanate (PZT). In some cases, the on-chip actuator sorts the particles by changing the flow movement transiently at the sorting junction. In some cases, the particle sorting is performed using optical methods, including but not limited to using scattered light and/or emitted fluorescence (detected by one or more photodetectors) as the signal to trigger sorting activation. In some cases, the particle sorting is performed using electrical methods (e.g., impedance measurements) and/or optical methods to obtain a validation signal to confirm the sorting status. In some cases, there is a time/sort delay between the time when a particle is optically detected and when the particle reaches the sorting junction. In some cases, a processor may implement a method to adjust for the time/sort delay by using the relation amongst the optical detection signal, the PZT actuator triggering signal, and the validation signal to increase the sorting efficiency and monitor the sorting status in real time.

In some embodiments, inner surfaces of the PZT chamber may be treated. In some embodiments, the inner surfaces of the PZT chamber may be treated to be hydrophobic. In some embodiments, the inner surfaces of the PZT chamber may be treated to increase the hydrophobicity of the inner surfaces. In some embodiments, the inner surfaces of the PZT chamber may be treated to be hydrophilic. In some embodiments, the inner surfaces of the PZT chamber comprises the wall formed by the actuator aperture. In some embodiments, the inner surfaces of the PZT chamber comprises the top and bottom covering over the actuator aperture. In some embodiments, the hydrophobicity of the inner surfaces of the PZT chamber may help purge the air from the PZT chamber. In some embodiments, the hydrophobicity of the inner surfaces of the PZT chamber may reduce the air volume in the PZT chamber. In some embodiments, the hydrophobicity of the inner surfaces of the PZT chamber may help reduce the number of air bubbles in the PZT chamber. In some embodiments, the hydrophobicity of the inner surfaces of the PZT chamber may help the PZT chamber be free of air bubbles. In some embodiments, the hydrophobicity of the inner surfaces of the PZT chamber may help the PZT chamber be filled with liquid. In some embodiments, the wall formed by the actuator aperture may have a different hydrophobicity than the covering over the actuator aperture. In some embodiments, the wall formed by the actuator aperture may be treated to be hydrophobic and the covering over the actuator aperture may be treated to be hydrophilic. In some embodiments, the wall formed by the actuator aperture may be hydrophobic and the covering over the actuator aperture may be hydrophilic.

Usually, the layers of the microchip are bonded to each other. In some cases, the layers of the microchip are directly bonded by at least one of thermal fusion bonding, welding, surface modification by UV and/or ozone, or solvent bonding. Alternatively or in combination, the layers may be indirectly bonded using another material to help in the bonding. In some cases, an adhesive is used to cover the aperture of the microfluidic chip substrate with the actuator. In some cases, the adhesive is a pressure sensitive adhesive (PSA). In some cases, the layers are indirectly bonded by at least one of adhesive bonding, microwave bonding, or use of an intermediate bonding layer.

Often, the microchip can be surface treated to change hydrophilicities of the microchannel, the at least two sorting channels, and the aperture of the microfluidic chip substrate. In some cases, the surface treatment is at least one of surface coating, attachment of active groups, plasma oxidation, thermal aging, and chemical coating. In some cases, the surface treatment results in a hydrophobic coating. In some cases, the surface treatment results in a hydrophilic coating.

In some cases, the first cover layer has a thickness of about 10 μm, 20 μm, 30 μm, 40 μm, 50 μm, 60 μm, 70 μm, 80 μm, 90 μm, 100 μm, 110 μm, 120 μm, 130 μm, 140 μm, 150 μm, 160 μm, 170 μm, 180 μm, 190 μm, 200 μm, 250 μm, 300 μm, 350 μm, 400 μm, 450 μm, 500 μm, 550 μm, 600 μm, 650 μm, 700 μm, 850 μm, 900 μm, 950 μm, or 1000 μm. In some cases, the first cover layer has a thickness of at least about 10 μm, 20 μm, 30 μm, 40 μm, 50 μm, 60 μm, 70 μm, 80 μm, 90 μm, 100 μm, 110 μm, 120 μm, 130 μm, 140 μm, 150 μm, 160 μm, 170 μm, 180 μm, 190 μm, 200 μm, 250 μm, 300 μm, 350 μm, 400 μm, 450 μm, or 500 μm. In some cases, the first cover layer has a thickness of at most about 10 μm, 20 μm, 30 μm, 40 μm, 50 μm, 60 μm, 70 μm, 80 μm, 90 μm, 100 μm, 110 μm, 120 μm, 130 μm, 140 μm, 150 μm, 160 μm, 170 μm, 180 μm, 190 μm, 200 μm, 250 μm, 300 μm, 350 μm, 400 μm, 450 μm, 500 μm, 550 μm, 600 μm, 650 μm, 700 μm, 850 μm, 900 μm, 950 μm, or 1000 μm. In some cases, the first cover layer has a length of at least about 0.1 cm, 0.5 cm, 1 cm, 2 cm, 3 cm, 4 cm, or 5 cm. In some cases, the first cover layer has a length of at most about 0.1 cm, 0.5 cm, 1 cm, 2 cm, 3 cm, 4 cm, 5 cm, 6 cm, 7 cm, 8 cm, 9 cm, or 10 cm. In some cases, the first cover layer has a width of at least about 0.1 cm, 0.5 cm, 1 cm, 2 cm, 3 cm, 4 cm, or 5 cm. In some cases, the first cover layer has a width of at most about 0.1 cm, 0.5 cm, 1 cm, 2 cm, 3 cm, 4 cm, 5 cm, 6 cm, 7 cm, 8 cm, 9 cm, or 10 cm.

In some cases, the second cover layer has a thickness of about 10 μm, 20 μm, 30 μm, 40 μm, 50 μm, 60 μm, 70 μm, 80 μm, 90 μm, 100 μm, 110 μm, 120 μm, 130 μm, 140 μm, 150 μm, 160 μm, 170 μm, 180 μm, 190 μm, 200 μm, 250 μm, 300 μm, 350 μm, 400 μm, 450 μm, 500 μm, 550 μm, 600 μm, 650 μm, 700 μm, 850 μm, 900 μm, 950 μm, or 1000 μm. In some cases, the second cover layer has a thickness of at least about 10 μm, 20 μm, 30 μm, 40 μm, 50 μm, 60 μm, 70 μm, 80 μm, 90 μm, 100 μm, 110 μm, 120 μm, 130 μm, 140 μm, 150 μm, 160 μm, 170 μm, 180 μm, 190 μm, 200 μm, 250 μm, 300 μm, 350 μm, 400 μm, 450 μm, or 500 μm. In some cases, the second cover layer has a thickness of no more than about 10 μm, 20 μm, 30 μm, 40 μm, 50 μm, 60 μm, 70 μm, 80 μm, 90 μm, 100 μm, 110 μm, 120 μm, 130 μm, 140 μm, 150 μm, 160 μm, 170 μm, 180 μm, 190 μm, 200 μm, 250 μm, 300 μm, 350 μm, 400 μm, 450 μm, 500 μm, 550 μm, 600 μm, 650 μm, 700 μm, 850 μm, 900 μm, 950 μm, or 1000 μm. In some cases, the second cover layer has a length of at least about 0.1 cm, 0.5 cm, 1 cm, 2 cm, 3 cm, 4 cm, or 5 cm. In some cases, the second cover layer has a length of at most about 0.1 cm, 0.5 cm, 1 cm, 2 cm, 3 cm, 4 cm, 5 cm, 6 cm, 7 cm, 8 cm, 9 cm, or 10 cm. In some cases, the second cover layer has a width of at least about 0.1 cm, 0.5 cm, 1 cm, 2 cm, 3 cm, 4 cm, or 5 cm. In some cases, the second cover layer has a width of at most about 0.1 cm, 0.5 cm, 1 cm, 2 cm, 3 cm, 4 cm, 5 cm, 6 cm, 7 cm, 8 cm, 9 cm, or 10 cm.

In some cases, the microfluidic chip substrate of the microchip has a thickness of about 0.1 mm, 0.2 mm, 0.3 mm, 0.4 mm, 0.5 mm, 0.6 mm, 0.7 mm, 0.8 mm, 0.9 mm, 1.0 mm, 1.5 mm, 2.0 mm, 2.5 mm, 3.0 mm, 3.5 mm, 4.0 mm, 4.5 mm, or 5.0 mm. In some cases, the microfluidic chip substrate of the microchip has a thickness of at least about 0.1 mm, 0.5 mm, 1.0 mm, 1.5 mm, 2.0 mm, 2.5 mm, 3.0 mm, 3.5 mm, 4.0 mm, 4.5 mm, or 5.0 mm. In some cases, the microfluidic chip substrate of the microchip has a thickness of no more than about 0.1 mm, 0.5 mm, 1.0 mm, 1.5 mm, 2.0 mm, 2.5 mm, 3.0 mm, 3.5 mm, 4.0 mm, 4.5 mm, or 5.0 mm.

In some embodiments, the aperture, also referred to as the PZT hole, on the microfluidic chip substrate has a diameter of about 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 21 mm, 22 mm, 23 mm, 24 mm, or 25 mm. In some embodiments, the aperture on the microfluidic chip substrate has a diameter of at least about 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 21 mm, 22 mm, 23 mm, 24 mm, or 25 mm. In some embodiments, the aperture on the microfluidic chip substrate has a diameter of no more than about 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 21 mm, 22 mm, 23 mm, 24 mm, or 25 mm.

In some embodiments, the aperture has a depth of about 0.5 mm to about 5 mm. In some embodiments, the aperture has a depth of about 0.5 mm, 1 mm, 1.5 mm, 2 mm, 2.5 mm, 3 mm, 3.5 mm, 4 mm, 4.5 mm, or 5 mm. In some embodiments, the aperture has a depth of at least about 0.5 mm, 1 mm, 1.5 mm, 2 mm, 2.5 mm, 3 mm, 3.5 mm, 4 mm, 4.5 mm, or 5 mm. In some embodiments, the aperture has a depth of no more than about 0.5 mm, 1 mm, 1.5 mm, 2 mm, 2.5 mm, 3 mm, 3.5 mm, 4 mm, 4.5 mm, or 5 mm.

In some embodiments, the microchannel on the microfluidic chip substrate, also referred herein as main microchannel or main channel, has a width of about 50 μm, 60 μm, 70 μm, 80 μm, 90 μm, 100 μm, 110 μm, 120 μm, 130 μm, 140 μm, 150 μm, 160 μm, 170 μm, 180 μm, 190 μm, 200 μm, 210 μm, 220 μm, 230 μm, 240 μm, 250 μm, 260 μm, 270 μm, 280 μm, 290 μm, 300 μm, 350 μm, 400 μm, 450 μm, or 500 μm. In some embodiments, the microchannel on the microfluidic chip substrate has a width of at least about 10 μm, 20 μm, 30 μm, 40 μm, 50 μm, 60 μm, 70 μm, 80 μm, 90 μm, 100 μm, 110 μm, 120 μm, 130 μm, 140 μm, 150 μm, 160 μm, 170 μm, 180 μm, 190 μm, 200 μm, 210 μm, 220 μm, 230 μm, 240 μm, 250 μm, 260 μm, 270 μm, 280 μm, 290 μm, 300 μm, 350 μm, 400 μm, 450 μm, or 500 μm. In some embodiments, the microchannel on the microfluidic chip substrate has a width of no more than about 50 μm, 60 μm, 70 μm, 80 μm, 90 μm, 100 μm, 110 μm, 120 μm, 130 μm, 140 μm, 150 μm, 160 μm, 170 μm, 180 μm, 190 μm, 200 μm, 210 μm, 220 μm, 230 μm, 240 μm, 250 μm, 260 μm, 270 μm, 280 μm, 290 μm, 300 μm, 350 μm, 400 μm, 450 μm, or 500 μm.

In some embodiments, the main microchannel on the microfluidic chip substrate has a depth of about 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 105 μm, 110 μm, 115 μm, 120 μm, 125 μm, 130 μm, 135 μm, 135 μm, 140 μm, 145 μm, 150 μm, 160 μm, 170 μm, 180 μm, 190 μm, 200 μm, 210 μm, 220 μm, 230 μm, 240 μm, 250 μm, 260 μm, 270 μm, 280 μm, 290 μm, or 300 μm. In some embodiments, the main microchannel on the microfluidic chip substrate has a depth of at least about 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 105 μm, 110 μm, 115 μm, 120 μm, 125 μm, 130 μm, 135 μm, 135 μm, 140 μm, 145 μm, 150 μm, 160 μm, 170 μm, 180 μm, 190 μm, 200 μm, 210 μm, 220 μm, 230 μm, 240 μm, 250 μm, 260 μm, 270 μm, 280 μm, 290 μm, or 300 μm. In some embodiments, the main microchannel on the microfluidic chip substrate has a depth of no more than about 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 105 μm, 110 μm, 115 μm, 120 μm, 125 μm, 130 μm, 135 μm, 135 μm, 140 μm, 145 μm, 150 μm, 160 μm, 170 μm, 180 μm, 190 μm, 200 μm, 210 μm, 220 μm, 230 μm, 240 μm, 250 μm, 260 μm, 270 μm, 280 μm, 290 μm, or 300 μm.

In some embodiments, the main microchannel on the microfluidic chip substrate has a width to depth ratio of about 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, or 4.0. In some embodiments, the main microchannel on the microfluidic chip substrate has a width to depth ratio of at least about 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, or 4.0. In some embodiments, the main microchannel on the microfluidic chip substrate has a width to depth ratio of no more than about 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.5, or 5.0.

In some embodiments, the sorting channel on the microfluidic chip substrate has a width of about 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 105 μm, 110 μm, 115 μm, 120 μm, 125 μm, 130 μm, 135 μm, 135 μm, 140 μm, 145 μm, 150 μm, 160 μm, 170 μm, 180 μm, 190 μm, 200 μm, 210 μm, 220 μm, 230 μm, 240 μm, 250 μm, 260 μm, 270 μm, 280 μm, 290 μm, or 300 μm. In some embodiments, the sorting channel on the microfluidic chip substrate has a width of at least about 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 105 μm, 110 μm, 115 μm, 120 μm, 125 μm, 130 μm, 135 μm, 135 μm, 140 μm, 145 μm, 150 μm, 160 μm, 170 μm, 180 μm, 190 μm, 200 μm, 210 μm, 220 μm, 230 μm, 240 μm, 250 μm, 260 μm, 270 μm, 280 μm, 290 μm, or 300 μm. In some embodiments, the sorting channel on the microfluidic chip substrate has a width of no more than about 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 105 μm, 110 μm, 115 μm, 120 μm, 125 μm, 130 μm, 135 μm, 135 μm, 140 μm, 145 μm, 150 μm, 160 μm, 170 μm, 180 μm, 190 μm, 200 μm, 210 μm, 220 μm, 230 μm, 240 μm, 250 μm, 260 μm, 270 μm, 280 μm, 290 μm, or 300 μm.

In some embodiments, all sorting channels on the microfluidic chip substrate have the same width. In some embodiments, all sorting channels on the microfluidic chip substrate have the different widths. In some embodiments, at least two of the sorting channels on the microfluidic chip substrate have the same width. In some embodiments, two of the sorting channels on the microfluidic chip substrate have the same width.

In some embodiments, the sorting channel on the microfluidic chip substrate has a depth of about 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 105 μm, 110 μm, 115 μm, 120 μm, 125 μm, 130 μm, 135 μm, 135 μm, 140 μm, 145 μm, 150 μm, 160 μm, 170 μm, 180 μm, 190 μm, 200 μm, 210 μm, 220 μm, 230 μm, 240 μm, 250 μm, 260 μm, 270 μm, 280 μm, 290 μm, or 300 μm. In some embodiments, the sorting channel on the microfluidic chip substrate has a depth of at least about 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 105 μm, 110 μm, 115 μm, 120 μm, 125 μm, 130 μm, 135 μm, 135 μm, 140 μm, 145 μm, 150 μm, 160 μm, 170 μm, 180 μm, 190 μm, or 200 μm. In some embodiments, the sorting channel on the microfluidic chip substrate has a depth of no more than about 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 105 μm, 110 μm, 115 μm, 120 μm, 125 μm, 130 μm, 135 μm, 135 μm, 140 μm, 145 μm, 150 μm, 160 μm, 170 μm, 180 μm, 190 μm, 200 μm, 210 μm, 220 μm, 230 μm, 240 μm, 250 μm, 260 μm, 270 μm, 280 μm, 290 μm, or 300 μm.

In some embodiments, all sorting channels on the microfluidic chip substrate have the same depth. In some embodiments, all sorting channels on the microfluidic chip substrate have the different In some embodiments, all sorting channels on the microfluidic chip substrate have the same depths. In some embodiments, at least two of the sorting channels on the microfluidic chip substrate have the same depth. In some embodiments, two of the sorting channels on the microfluidic chip substrate have the same depth.

In some embodiments, the sorting channel on the microfluidic chip substrate has a width to depth ratio of about 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, or 3.0. In some embodiments, the sorting channel on the microfluidic chip substrate has a width to depth ratio of at least about 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, or 3.0. In some embodiments, the sorting channel on the microfluidic chip substrate has a width to depth ratio of no more than about 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.5, or 5.0.

### III. Thermoplastic and Cycloolefin Polymer

Provided herein are methods, devices, and systems comprising a particle sorting cartridge comprising a macro cartridge and a microchip made of thermoplastics, including but not limited to cycloolefin polymers. In scaling up the production of microfluidic cartridges and other microfluidics-based components, thermoplastics may have a number of advantages over PDMS. While PDMS can provide high optical transmittivity and high gas permittivity, PDMS can suffer from channel deformation, low solvent and acid/base resistivity, evaporation, sample absorption, leaching, and hydrophobic recovery, and low-volume throughput in fabrication. Thermoplastics offer an alternative material that can be used in place or in combination with PDMS or other materials.

Thermoplastics are synthetic polymers that have various surface properties. Usually, thermoplastics can be rigid polymer materials and have good mechanical stability, a low water-absorption percentage, and resistance to organic-solvent and acid/base. These characteristics are advantageous in methods, devices, and systems using microfluidics, especially when they involve a high-pressure fluid injection. Examples of thermoplastics include but are not limited to as poly(methyl methacrylate) (PMMA), polycarbonate (PC), polystyrene (PS), polyvinyl chloride (PVC), polyimide (PI), and the family of cyclic olefin polymers. The family of cyclic olefin polymers, also referred herein as cycloolefin polymers, are made from at least one cyclic monomer and include but are not limited to cyclic olefin copolymer (COC), cyclic olefin polymer (COP), and cyclic block copolymer (CBC).

The use of cycloolefin polymers, such as COC, COP, and CBC, allows the microchip or microfluidic cartridge components to be fabricated by a rapid prototyping or replication methods that are conduce for large scale production. These methods include but are not limited to injection molding, extrusion, film extrusion, injection blow molding, extrusion blowing, hot embossing, roller embossing, computer numerical controlled (CNC) milling, laser ablation, digital craft cutting, and 3D printing. Sometimes, large-scale production or high-volume production refers to producing at least 100 pieces of the microchip or microfluidic cartridge component per month, 500 pieces per month, 1,000 pieces per month, or 2,000 pieces per month.

The use of cycloolefin polymers and thermoplastics allows the various layers of microchip or microfluidic cartridge components to be bonded to each other or other cartridge components by a variety of approaches. The layers may be directly bonded by a bonding method, including but not limited to thermal fusion bonding, welding, surface modification by UV and/or ozone, or solvent bonding. Alternatively or in combination, the layers may be indirectly bonded using another material to help in the bonding. Indirect bonding methods include but are not limited to adhesive bonding, microwave bonding, or use of an intermediate bonding layer, such as epoxy, adhesive tape, pressure sensitive adhesive (PSA), a metal or a chemical reagent.

Sometimes, the materials for the microchip or microfluidic cartridge components undergo surface modification in whole or in part to tune its hydrophilicity or hydrophobicity to have a desired physical property. Often, the surface treatment includes but are not limited to surface coating, attachment of active groups, plasma oxidation, thermal aging, and chemical coating, to change its hydrophilicity or hydrophobicity.

The use of cycloolefin polymers, such as COC, COP, and CBC, in the microchip components and microfluidic cartridge provides various advantages. Usually, cycloolefin polymers have good mechanical stability, excellent resistance to solvent and acid/bases, excellent optical transmittivity in both the visible and UV wavelength ranges, low autofluorescence, low birefringence, low dielectric constant, lower water absorption, and good biocompatibility. In some cases, the cycloolefin polymers are extremely clear and offer optically suitable replacement for glass that are less prone to breaking. In some cases, the cycloolefin polymers have a wide thermal property range. In some cases, the thermal property range is between about 60° C. to about 145° C., about 70° C. to about 155° C., about 70° C. to about 150° C., about 80° C. to about 140° C., about 90° C. to about 130° C., or about 100° C. to about 120° C.

In some cases, the mechanical property of the microchip and microfluidic cartridge components may be adjusted by the dimensions of the components, such as thickness. In some cases, a thin film of cycloolefin polymer may be used for a microchip and microfluidic cartridge component, such as the first cover layer or the second cover layer that cover another layer having microfluidic channels. In some cases, the tensile modulus of the cycloolefin polymer film is at least 10 MPa, 20 MPa, 30 MPa, 40 MPa, 50 MPa, 60 MPa, 70 MPa, 80 MPa, 90 MPa, or 100 MPa. In some cases, the tensile modulus of the cycloolefin polymer film is measured by ISO 527-2/1A test standard. In some cases, the tensile strain at failure of the cycloolefin polymer film is at least 100%, 200%, 300%, 400%, 500%, 600%, 700%, 800%, 900%, or 1000%. In some cases, the tear strength of the cycloolefin polymer film is at least 10 kN/m, 20 kN/m, 30 kN/m, 40 kN/m, 50 kN/m, 60 kN/m, 70 kN/m, 80 kN/m, 90 kN/m, or 100 kN/m. In some cases, the tensile strain at failure of the cycloolefin polymer film is measured by ISO 527-2/1A test standard. In some cases, the tear strength of the cycloolefin polymer film is measured by ISO 34-1 test standard.

In some cases, a cycloolefin polymer may be used for a microchip and microfluidic cartridge component, such as the microfluidic chip substrate or macro cartridge. In some cases, the tensile modulus of the cycloolefin polymer is at least 10 MPa, 20 MPa, 30 MPa, 40 MPa, 50 MPa, 60 MPa, 70 MPa, 80 MPa, 90 MPa, or 100 MPa. In some cases, the tensile modulus of the cycloolefin polymer film is measured by ISO 527-2/1A test standard. In some cases, the tensile strain at failure of the cycloolefin polymer is at least 100%, 200%, 300%, 400%, 500%, 600%, 700%, 800%, 900%, or 1000%. In some cases, the tear strength of the cycloolefin polymer film is at least 10 kN/m, 20 kN/m, 30 kN/m, 40 kN/m, 50 kN/m, 60 kN/m, 70 kN/m, 80 kN/m, 90 kN/m, or 100 kN/m. In some cases, the tensile strain at failure of the cycloolefin polymer is measured by ISO 527-2/1A test standard. In some cases, the tear strength of the cycloolefin polymer is measured by ISO 34-1 test standard.

### Definitions

Unless defined otherwise, all terms of art, notations and other technical and scientific terms or terminology used herein are intended to have the same meaning as is commonly understood by one of ordinary skill in the art to which the claimed subject matter pertains. In some cases, terms with commonly understood meanings are defined herein for clarity and/or for ready reference, and the inclusion of such definitions herein should not necessarily be construed to represent a substantial difference over what is generally understood in the art.

Throughout this application, various embodiments may be presented in a range format. It should be understood that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

As used in the specification and claims, the singular forms “a”, “an” and “the” include plural references unless the context clearly dictates otherwise. For example, the term “a sample” includes a plurality of samples, including mixtures thereof.

As used herein, the term ‘about’ a number refers to that number plus or minus 10% of that number. The term ‘about’ a range refers to that range minus 10% of its lowest value and plus 10% of its greatest value.

As used herein, the term ‘particle’ may refer to a cell, a bacterium, a virus, a micelle, a vesicle, a droplet, or a particle in a sample. The term particle may refer to any discrete object that can be distinguished from its surrounding medium by the methods, devices, and systems described herein. A sample usually comprises a plurality of particles and can be process using the devices, systems, and methods described herein to sort a single particle individually or a grouping of particles.

The terms “determining”, “measuring”, “evaluating”, “assessing,” “assaying,” and “analyzing” are often used interchangeably herein to refer to forms of measurement, and include determining if an element is present or not (for example, detection). These terms can include quantitative, qualitative or quantitative and qualitative determinations. Assessing is alternatively relative or absolute. “Detecting the presence of” includes determining the amount of something present, as well as determining whether it is present or absent.

The terms “subject,” “individual,” or “patient” are often used interchangeably herein. A “subject” can be a biological entity containing expressed genetic materials. The biological entity can be a plant, animal, or microorganism, including, for example, bacteria, viruses, fungi, and protozoa. The subject can be tissues, cells and their progeny of a biological entity obtained in vivo or cultured in vitro. The subject can be a mammal. The mammal can be a human. The subject may be diagnosed or suspected of being at high risk for a disease. The disease can be endometriosis. In some cases, the subject is not necessarily diagnosed or suspected of being at high risk for the disease.

The term “in vitro” is used to describe an event that takes places contained in a container for holding laboratory reagent such that it is separated from the living biological source organism from which the material is obtained. In vitro assays can encompass cell-based assays in which cells alive or dead are employed. In vitro assays can also encompass a cell-free assay in which no intact cells are employed.

The section headings used herein are for organizational purposes only and are not to be construed as limiting the subject matter described.

### EXAMPLES

The following examples are included for illustrative purposes only and are not intended to limit the scope of the invention.

### Example 1: Microfluidic Cartridge with PDMS Microchip

Provided herein is an exemplary embodiment of a microfluidic cartridge with a PDMS microchip. The layers of the microfluidic cartridge include 1) first cover layer made of glass, 2) microfluidic chip substrate made of PDMS, 3) PSA layer, 4) PZT actuator, 5) macro cartridge made of COC, and 6) film backing made of COC. Layers 1-4 comprise the PDMS microchip. The first cover layer covers the microfluidic chip substrate layer completely.

### Example 2: Microfluidic Cartridge with COC Microchip

Provided herein is an exemplary embodiment of a microfluidic cartridge with a COC microchip. The layers of the microfluidic cartridge include 1) first cover layer comprising COC film, 2) microfluidic chip substrate comprising COC, 3) PSA layer, 4) PZT actuator, 5) macro cartridge made of COC, and 6) film backing made of COC. Layers 1-4 comprise the COC microchip. The first cover layer covers the microfluidic chip substrate layer completely.

### Example 3: Microfluidic Cartridge with COC Microchip with Second Cover Layer

Provided herein is an exemplary embodiment of a microfluidic cartridge with a COC microchip having a second cover layer. The layers of the microfluidic cartridge include 1) second cover layer comprising COC, 2) first cover layer comprising COC film, 3) microfluidic chip substrate comprising COC, 4) PSA layer, 5) macro cartridge made of COC, 6) film backing made of COC, and 7) PZT actuator. Layers 1-4 and 7 comprise the COC microchip. The first cover layer covers the microfluidic chip substrate layer completely. The second cover layer comprising COC (layer 1) covers the entire surface of the first cover layer (layer 2), which cover the entire surface of the microfluidic chip substrate comprising COC (layer 3) including the triangular channel, the microchannel, sorting channels, and the PZT hole.

### Example 4: Microfluidic Cartridge with COC Microchip with Second Cover Layer

Provided herein is an exemplary embodiment of a microfluidic cartridge with a COC microchip having a second cover layer. The layers of the microfluidic cartridge include 1) second cover layer comprising COC, 2) first cover layer comprising COC film, 3) microfluidic chip substrate comprising COC, 4) PSA layer, 5) macro cartridge made of COC, 6) film backing made of COC, and 7) PZT actuator. Layers 1-4 and 7 comprise the COC microchip. The first cover layer covers the microfluidic chip substrate layer completely. The second cover layer comprising COC (layer 1) covers the first cover layer (layer 2) partially with a pentagonal cutout as seen on the second cover layer 210 of FIG. 2. The second cover layer also covers the microfluidic chip substrate partially, covering the microchannel, sorting channels, and the PZT hole but not the triangular channel area.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

1. A microchip for sorting a plurality of particles in a sample comprising:
a microfluidic chip substrate, the microfluidic chip substrate comprising a microchannel, at least two sorting channels, and an aperture that are configured to be in fluid communication with each other, wherein the microfluidic chip substrate comprises a cycloolefin polymer;
a first cover layer, the first cover layer configured to cover the microfluidic chip substrate, wherein the first cover layer comprises a cycloolefin polymer; and
a piezoelectric actuator, the piezoelectric actuator configured to cover the aperture on an opposite side of the microfluidic chip substrate from the first cover layer.

2. The microchip of claim 1, wherein the cycloolefin polymer for the first cover layer is cyclic olefin copolymer (COC).

3. The microchip of claim 2, wherein the first cover layer comprises a COC film.

4. The microchip of claim 1, wherein the cycloolefin polymer for the first cover layer is cyclic olefin polymer (COP).

5. The microchip of claim 1, wherein the microfluidic chip substrate is injection molded.

6. The microchip of claim 5, wherein the cycloolefin polymer for the microfluidic chip substrate comprises COC.

7. The microchip of claim 5, wherein the cycloolefin polymer for the microfluidic chip substrate comprises COP.

8. The microchip of claim 1, wherein the cycloolefin polymer for the first cover layer or the microfluidic chip substrate has high optical transparency.

9. The microchip of claim 1, wherein the cycloolefin polymer for the first cover layer or the microfluidic chip substrate has low autofluorescence.

10. The microchip of claim 1, wherein the microchip further comprises a second cover layer, the second cover layer is configured to cover at least a portion of the first cover layer on an opposite side of the first cover layer from the microfluidic chip substrate.

11. The microchip of claim 10, wherein the second cover layer is configured to cover entire area of the microfluidic chip substrate.

12. The microchip of claim 10, wherein the second cover layer and the first cover layer are configured to cover the aperture of the microfluidic chip substrate.

13. The microchip of claim 10, wherein the microfluidic chip substrate comprises an actuator reservoir in fluidic communication with a sorting junction, and a second reservoir in fluidic communication with the sorting junction, wherein the second reservoir is substantially opposite the actuator reservoir, and wherein the second cover layer has a cutout, the cutout configured to not cover at least a portion of the second reservoir.

14. The microchip of claim 10, wherein the first cover layer and the second cover layer help maintain a pressure in the aperture, the pressure lower than a pressure required for delaminating the first cover layer or the piezoelectric actuator from the microfluidic chip substrate.

15. The microchip of claim 10, wherein the first cover layer and the second cover layer cover the microfluidic chip substrate to allow or do not restrict a fluid flow in the microchannel and the at least two sorting channels of the microfluidic chip substrate.

16. The microchip of claim 1, wherein the piezoelectric actuator comprises lead zirconate titanate (PZT).

17. The microchip of claim 1, wherein an adhesive is used to cover the aperture of the microfluidic chip substrate with the piezoelectric actuator, wherein the adhesive is a pressure sensitive adhesive (PSA).

18. The microchip of claim 1, wherein the microchip is surface treated to change hydrophilicities of the microchannel, the at least two sorting channels, and the aperture of the microfluidic chip substrate.

19. The microchip of claim 18, wherein the surface treatment is at least one of surface coating, attachment of active groups, plasma oxidation, thermal aging, and chemical coating.

20. The microchip of claim 1, wherein the microchip is configured to connect to a macro cartridge, the macro cartridge comprising a cycloolefin polymer and having a cutout configured to hold the microchip.

21. The microchip of claim 20, wherein the macro cartridge comprises cycloolefin polymer.

22. The microchip of claim 20, wherein the macro cartridge is configured to attach to a film backing on an opposite side of the macro cartridge from the microchip.

23. The microchip of claim 22, wherein the film backing comprises cycloolefin polymer.

24. The microchip of claim 20, wherein an adhesive is used to attach the microchip to the macro cartridge, wherein the adhesive is a pressure sensitive adhesive (PSA).

25. The microchip of claim 1, wherein the microchip further comprises a piezoelectric actuator neck, a sample inlet, a sheath inlet, a purge hole, a purge neck, an outlet connected to each of the sorting channels, a triangular channel opposite the actuator neck, and at least two sets of alignment markers.

26. The microchip of claim 20, wherein the macro cartridge further comprises an identification tag.

27. A microfluidic cartridge for sorting a plurality of particles in a sample comprising:
a microchip, the microchip comprising
a microfluidic chip substrate, the microfluidic chip substrate comprising a microchannel, at least two sorting channels, and an aperture that are configured to be in fluid communication with each other, wherein the microfluidic chip substrate comprises a cycloolefin polymer;
a first cover layer, the first cover layer configured to cover the microfluidic chip substrate, wherein the first cover layer comprises a cycloolefin polymer; and
a piezoelectric actuator, the piezoelectric actuator configured to cover the aperture on an opposite side of the microfluidic chip substrate from the first cover layer; and
a macro cartridge comprising a cycloolefin polymer and having a cutout configured to hold the microchip.

28. A method of preparing a microchip for sorting a plurality of particles in a sample comprising:
(a) fabricating a microfluidic chip substrate, the microfluidic chip substrate comprising a microchannel, at least two sorting channels, and an aperture that are configured to be in fluid communication with each other, wherein the microfluidic chip substrate comprises a cycloolefin polymer;
(b) aligning a first cover layer comprising a cycloolefin polymer on one side of the microfluidic chip substrate and a piezoelectric actuator on the other side of the microfluidic chip substrate, wherein the piezoelectric actuator covers the aperture of the microfluidic chip substrate; and
(c) attaching the first cover layer and the piezoelectric actuator to the microfluidic chip substrate.

29. The method of claim 28, wherein the fabrication in step (a) is by injection molding.

30. The method of claim 28, wherein the method further comprises aligning and attaching a second cover layer to cover at least a portion of the first cover layer on an opposite side of the first cover layer from the microfluidic chip substrate.

31. The method of claim 28, wherein the method further comprises treating surfaces of the microchip by at least one of surface coating, attachment of active groups, plasma oxidation, thermal aging, and chemical coating.
